(19) United States
(12) Patent Application Publication
(10) Pub. No.: US 2010/0095566 A1
(43) Pub. Date: Apr. 22, 2010

(54) Greeting card

(75) Inventor: John B. Gustafson, JR., (US)

Correspondence Address: MARSHALL, GERSTEIN & BORUN LLP, 233 SOUTH WACKER DRIVE, 6300 SEARS TOWER, CHICAGO, IL, 60606-6357, US

(73) Assignee: JOHNS-BYRNE COMPANY, Niles, IL (US)

(21) Appl. No.: 12/255,338

(22) Filed: Oct. 21, 2008

(51) Int. Cl. G09F 1/00; B42D 15/02

(52) U.S. Cl. 40/124.01; 283/67

(57) ABSTRACT

A new kind of greeting card uses the stock removed from a cut opening to create a raised portion on another page. To make the card, a die cuts around a portion of the perimeter of an area on the stock that will be transferred to form the raised portion of the card. This transfer area is temporarily left in place in its original position on the stock. Adhesive is applied to an adhesive area on either the back of the transfer area or on the portion of the stock that will form the page where the transfer area will be adhered. When the stock is folded into a card, the adhesive is sandwiched between the back of the transfer area and the portion of the stock where the transfer area is to be adhered. When the card is opened, the transfer area is separated from its original position, creating a cut opening on one page of the card. The adhesive holds the transfer area to the other page, creating a raised portion on that page. In a multi-page card, transfer areas from multiple pages can be stacked on top of each other.

### CROSS-REFERENCE TO RELATED APPLICATIONS

Not applicable.

### FIELD OF THE INVENTION

This invention relates to a new method for making printed cards, such as greeting cards.

### BACKGROUND OF THE INVENTION

Greeting cards are a staple product of stationery supply and greeting card stores and are purchased by individuals to send a message to a friend or family member. A typical greeting card is made from of a folded paper stock and has pages that have a preprinted message or picture. Some cards have cut openings that allow portions of one page to be seen through another page.

Novelty features, such as a pop-out, a sleeve, or a raised image can make a card more desirable, but also require additional manufacturing steps and thus make the card more expensive to produce.

The applicants have found an efficient way to produce cards that have both a cut opening on one page and a raised portion on another page.

### SUMMARY OF THE DISCLOSURE

The new method uses the stock removed from the cut opening to create a raised portion on another page. Adhesive is used to glue the removed stock to the other page, and the folding process itself is used to set the adhesive. The transferred portion is separated from the original page when the card is opened.

To use the method, a die cuts around a portion of the perimeter of an area on the stock that will be transferred to form the raised portion of the card. This transfer area is temporarily left in place in its original position on the stock, held in place, for example, by small nicks that are common in die cutting.

Adhesive is applied to an adhesive area on either the back of the transfer area or on the portion of the stock that will form the page where the transfer area will be adhered. The stock is then folded in a folding machine, during which time the adhesive is sandwiched between the back of the transfer area and the portion of the stock where the transfer area is to be adhered. After the folded stock is removed from the folding machine and the adhesive cures, opening the folded card separates the transfer area from its original position, creating a cut opening on one page of the card. The adhesive holds the transfer area to the other page, creating a raised portion on that page.

### BRIEF DESCRIPTION OF THE DRAWINGS

FIG. 1 is a view of one example of a printed card made in accordance with the invention.

FIG. 2 is a view of the stock that can be used to form the card seen in FIG. 1.

FIG. 3 is a view of the stock seen in FIG. 2, after adhesive has been applied.

FIG. 4 is a view of the stock being folded.

FIG. 5 is a side view of the stock in its folded position.

FIG. 6 is a view of another example of a printed card made in accordance with the invention.

### DETAILED DESCRIPTION

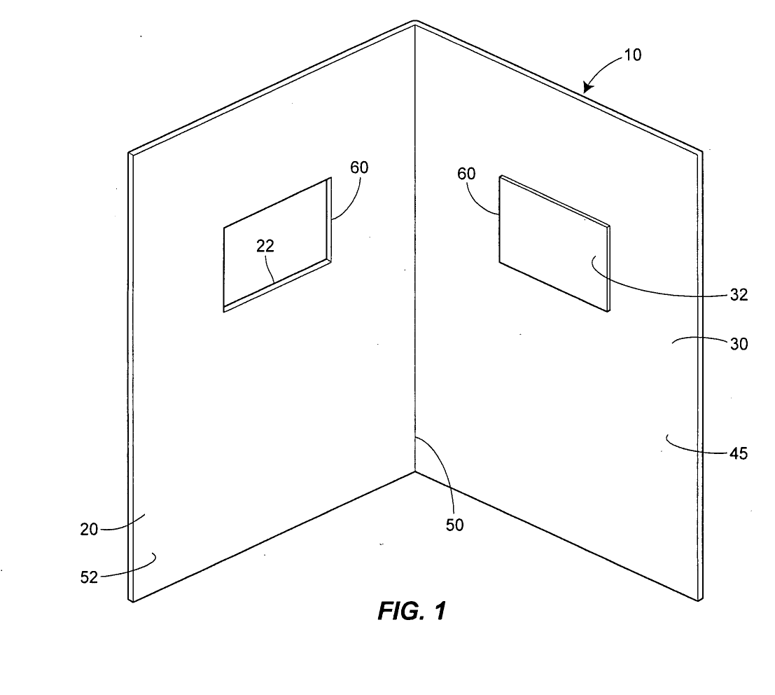

The card 10 seen in FIG. 1 is a 4″ by 6″ card made from conventional paper stock. It has a front page 20 with a 2″ high by 3″ wide cut opening 22 and a back page 30 with a raised portion 32 that fits that is the same size as (and fits within) the cut opening. The possible shapes and arrangements of the cut openings and raised portions are limitless: the cut openings could be virtually any shape, and the card could have multiple cut openings and raised portions, on the same or different pages. In addition, as explained below, the invention can also be used to make multiple-page cards that have stacked raised portions.

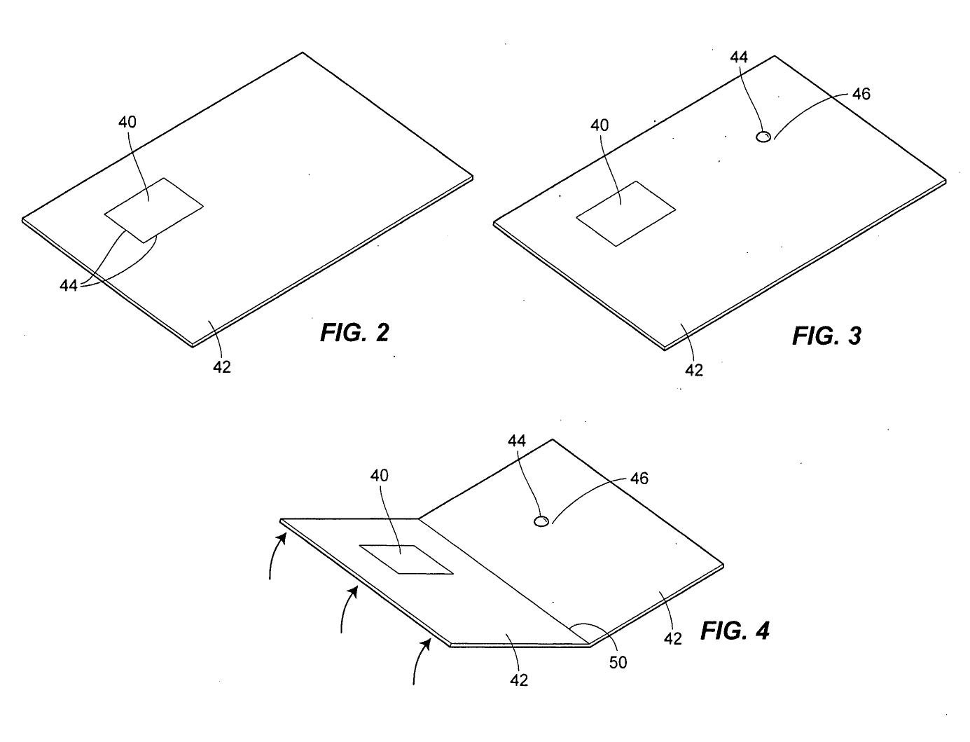

The card 10 uses the stock removed from the cut opening 22 to create the raised portion 32. To make the card, a conventional die can be used to cut around a portion of the perimeter of the area on the stock that will be transferred to form the raised portion. As seen in FIG. 2, this transfer area 40 is temporarily left in place in its original position on the stock 42, held in place, for example, by small nicks that are common in die cutting. In this example, the cuts 44 are made all the way around the periphery of the selected area, with only a few 0.015 of an inch wide nicks being spaced conveniently around the transfer area. Depending upon the nature of the stock, the number and the width of the nicks may vary. The nicks need to be easily broken yet strong enough to stay intact during the folding process.

Adhesive is applied to an adhesive area on either the back of the transfer area 40 or on the portion of the stock 42 that will form the page where the transfer area will be adhered. In the example seen in FIG. 3, the adhesive area is a portion 46 of the stock 42 that will form the facing side 45 of the back page 30 of the card. The adhesive may require different properties based on the material being glued and the size of the piece being affixed, and the particular adhesive used can vary depending on the size of the piece and the type of substrate. Here, the adhesive 44 is applied to the adhesive area in a series of ⅛″ diameter glue dots. The adhesive can be applied, for example, by a Nordson glue system or similar type of glue application technology common on straight line folder gluers. In certain applications, a pad gluing system may be used to apply the glue to the area required. This is sometimes found on folder gluers or inline web applications. The type and quantity of adhesive can be varied depending upon the nature of the stock, the size of the cut opening 22, and other factors.

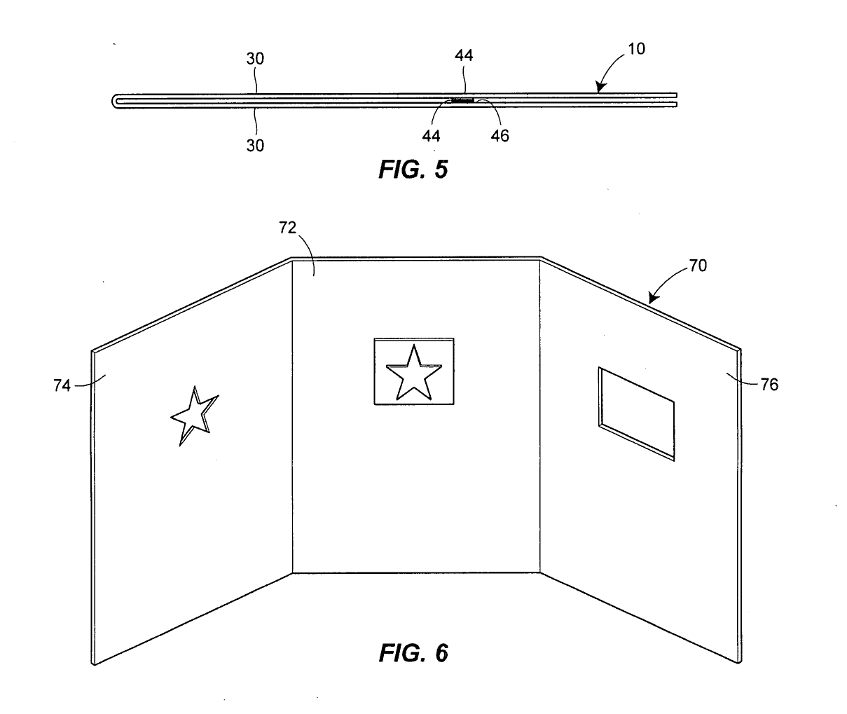

After the adhesive is applied, the stock 42 is then folded, as seen in FIG. 4, in the same process that is used to create the fold line 50 that separates the front and back pages of the card. During this folding, which can be done on a conventional folding machine, the adhesive 44 is sandwiched between the back of the transfer area 40 and the adhesive portion of the stock 42 where the transfer area is to be adhered (FIG. 5), setting the adhesive. (As used here, “setting” means that the adhesive is placed in firm contact with both the portion of the stock that will form the raised portion and with the portion of the stock where the raised portion is to be adhered: in some circumstances, curing of the adhesive could occur later.) It is not always necessary for the adhesive area to be co-extensive with the transfer area, but the adhesive should not spread beyond the perimeter of the transfer area.

After the folded stock is removed from the folding machine and the adhesive cures, opening the folded card (which can be done either by a series of rollers during the manufacturing process or by the consumer) separates the transfer area 40 from its original position, creating the cut opening 22 on one page of the card. At the same time, the adhesive holds the transfer area on the other page, creating the raised portion 32 on that page. Vestiges of the nicks 60 may be found on the cut opening and on the raised portion: when the card has been formed using this method, the locations of those vestiges will match.

The invention can also be used to make more elaborate cards. The three-panel, bi-fold card 70 seen in FIG. 6 has a back panel 72, a left-side panel 74 that folds over it and forms a front page, and a right-side panel 76 that folds in between the back and front panels. The back panel has a “double-height” raised portion 80 that is made of one transfer area 82 cut from the left-side panel, with another transfer area 84 cut from the right-side panel glued on top of it. As seen in this example, the stacked transfer areas need not be the same size or shape.

In some circumstances, it may not be desirable or even possible to apply adhesive to both sides of the original stock. The illustrated bi-fold card 70 can be made by applying adhesive to only one face of the stock: the face that forms both the back face 90 of the left-side panel and the back face 92 of the right-side panel. When the card is folded, the transfer area 82 on the left-side panel is stacked in alignment with the transfer area 84 on the right-side panel. The adhesive on the back face of the right-side panel (behind the transfer area 84 on that panel) is pressed into the back panel, and adhesive on the back face of the left-side panel (behind the transfer area 82 on that panel) is pressed onto the front side of the transfer area of the right-side panel. When the card is opened, the transfer area from the front panel passes through cut opening on the right-side panel, remaining part of the raised portion on the back panel.

This description of various embodiments of the invention has been provided for illustrative purposes. Revisions or modifications may be apparent to those of ordinary skill in the art without departing from the invention. The full scope of the invention is set forth in the following claims.

What is claimed is:

1. A method for making a printed card that uses the steps of:
making a die cut around a portion of a perimeter of a selected transfer area in a stock;
applying adhesive to an adhesive area of the stock; and
folding the stock into a card and simultaneously pressing the adhesive between the selected transfer area and a portion of a facing side on another page.

2. A method as recited in claim 1, in which:
the adhesive area and the selected transfer area are on opposite faces of the same page of the card.

3. A method as recited in claim 1, in which:
the adhesive area and the selected transfer area are on different pages.

4. A method as recited in claim 1, in which:
a second die cut is made around a portion of a perimeter of a second transfer area on an area of the stock that will form another page; and
the stock is folded so that the two transfer areas are stacked in alignment and adhere together.

5. A method as recited in claim 1, in which the die cut is made substantially all the way around the selected transfer area.

6. A greeting card that has:
a first page that has a cut opening; and
another page that has a raised portion that fits within the cut opening.

7. A greeting card as recited in claim 6, in which the raised portion is substantially the same shape as the cut opening.

8. A greeting card as recited in claim 6, in which:
the raised portion is a distinct layer of stock that is glued to the page.

9. A greeting card as recited in claim 6, in which:
vestiges of nicks on the cut opening match vestiges of nicks on the raised portion.

10. A method for making a printed greeting card that has a first page with a cut opening and another page that has a raised portion that fits within the cut opening, the method using the steps of:
making a die cut around a portion of a perimeter of a transfer area on a stock;
applying adhesive to an adhesive area on the stock; and
folding the stock into the card and simultaneously pressing the adhesive between the selected transfer area and a portion of a facing side on another page.
